(19) United States
(12) Patent Application Publication
(10) Pub. No.: US 2008/0170258 A1
(43) Pub. Date: Jul. 17, 2008

(54) IMAGE FORMING APPARATUS

(76) Inventor: Miho YAMAMURA, Nara-shi (JP)

Correspondence Address: BIRCH STEWART KOLASCH & BIRCH, PO BOX 747, FALLS CHURCH, VA, 22040-0747, US

(21) Appl. No.: 11/967,819

(22) Filed: Dec. 31, 2007

(30) Foreign Application Priority Data
Jan. 15, 2007 (JP) 2007-006138

(51) Int. Cl. G06F 15/00

(52) U.S. Cl. 358/1.15; 340/686.6

(57) ABSTRACT

An image forming apparatus is provided in which a waiting time and an ending processing corresponding to the processing state of the apparatus such as printing, no paper, running out of toner, reading, paper jam are executed when a user leaves the image forming apparatus. The image forming apparatus includes a human body detecting portion that detects the distance from the apparatus to the user, and a control portion that when the distance to the user becomes not less than a predetermined distance or out of a detection area, causes the apparatus to automatically change its state to a given state. The image forming apparatus executes an ending processing after the passage of a predetermined time, based on the processing state of the apparatus. The predetermined time for execution of the ending processing can be set separately for each user.

### CROSS-NOTING PARAGRAPH

This Non-provisional application claims priority under 35 U.S.C. §119 (a) on Patent Application No. 2007-006138 filed in JAPAN on Jan. 15, 2007, the entire contents of which are hereby incorporated herein by reference.

### FIELD OF THE INVENTION

The present invention relates to an image forming apparatus that automatically returns to a given state when a user of the image forming apparatus leaves the apparatus.

### BACKGROUND OF THE INVENTION

In recent years, various apparatuses and devices have been automated to improve user's convenience. These apparatuses and devices are provided with a sensor that detects an object approaching the apparatus or device, and this sensor automatically turns on and off the apparatus or device in response to the movement of the object approaching the apparatus or device. Such a mechanism is widely put into practical use, for example, as an automatic faucet frequently used in a toilet that detects an approaching hand to automatically turn on and off the water to prevent the water from being wasted. For another example, various kinds of mechanisms such as shifting to a low-power mode when no input is received for a predetermined time are incorporated in an image forming apparatus which is now one of the indispensable office machines, from the requirement of saving energy.

For example, Japanese Laid-Open Patent Publication No. 05-045471 discloses an image forming apparatus that controls the apparatus (e.g., on-off control of a main switch) by detecting the distance between the apparatus and a person and the direction of movement taken by the person. Japanese Laid-Open Patent Publication No. 05-045471 also discloses the use of an ultrasonic distance sensor and other various kinds of sensors utilizing infrared rays, an electric wave, a laser beam, etc., for the detection of the distance between an apparatus and a person and the direction of movement taken by the person.

Japanese Laid-Open Patent Publication No. 03-096969 discloses a copier provided with a human body detecting means placed by the copier to detect the distance from the copier to an operator. The copier turns off an indicator of an operation portion when it detects that the operator leaves the copier, or shifts into a warmup mode to promote energy saving when it detects no operator.

An image forming apparatus, however, may change its operational state to such a state as an energy-saving mode, or log-out, because it detects no operator and determines that the use of the apparatus is over while a user of the apparatus leaves the apparatus, for example, to fetch the sheets of paper from a paper storage. In this case, the user has to wait until the image forming apparatus returns from the energy-saving mode to a steady mode. In addition, logging out from the apparatus results in system resetting, which forces the user to log in again and execute the prescribed setting from the beginning. This leads to worse efficiency in the use of the apparatus.

### SUMMARY OF THE INVENTION

The object of the present invention is to provide an image forming apparatus that when a user leaves the apparatus in a state of printing, no paper, running out of toner, etc., allows to wait for a period or executes an ending processing, respectively corresponding to each state of the apparatus.

The image forming apparatus of the present invention includes a human body detecting portion that detects the distance from the apparatus to a users and a control portion that automatically shifts the apparatus to a given state when the distance to the user becomes equal to or more than a predetermined distance or the user is out of a detection area. The image forming apparatus executes an ending processing after the passage of a predetermined time based on the processing state of the apparatus. The predetermined time can be set separately for each user. The processing state of the apparatus means that the apparatus is in a state such as printing, reading, paper jam, running out of toner, or no paper.

The ending processing is an energy-saving processing of the power supply of the apparatus, a work suspension processing of printing or reading, or a user log-out processing. It is desirable to suspend the operation of the apparatus and execute the log-out processing regardless of the processing state of the apparatus in the case of image processing involving confidential information. When a person other than the user is detected for a certain period of time or longer in a detection area before the passage of the predetermined time, the image forming apparatus may execute the log-out processing regardless of the processing state of the apparatus.

The image forming apparatus may cause a communication portion to notify the user of execution of the ending processing after the passage of the predetermined time. When a person other than the user is detected for a certain period of time or longer in the detection area before the passage of the predetermined time, the image forming apparatus may cause the communication portion to notify the user of execution of a work suspension processing or the log-out processing.

### BRIEF DESCRIPTION OF THE DRAWINGS

FIGS. 1A and 1B are explanatory views of the relation between the operations by a user and a MFP;

FIG. 2 is a diagrammatic view of measurement by the MFP of the distance from the MFP to a user;

FIG. 3 is a block diagram for illustrating the scheme of an image forming apparatus of the present invention;

FIGS. 4A and 4B depict examples of menus for setting a waiting time to the MFP based on a processing state;

FIGS. 5A and 5B depict examples of menus for setting an ending processing to the MFP based on a processing state;

FIG. 6 depicts an example of a setting table based on the processing state of the MFP;

FIG. 7 is a flowchart for illustrating an example of the basic form of use of the image forming apparatus of the present invention;

FIG. 8 is a flowchart for illustrating an example of another form of use of the image forming apparatus of the present invention;

FIG. 9 is a flowchart for illustrating an example of still another form of use of the image forming apparatus of the present invention;

FIG. 10 is a flowchart for illustrating an example of still another form of use of the image forming apparatus of the present invention;

FIG. 11 is a flowchart for illustrating an example of still another form of use of the image forming apparatus of the present invention;

FIG. 12 is a flowchart for illustrating an example of still another form of use of the image forming apparatus of the present invention; and

FIG. 13 is a flowchart for illustrating an example of still another form of use of the image forming apparatus of the present invention.

### PREFERRED EMBODIMENTS OF THE INVENTION

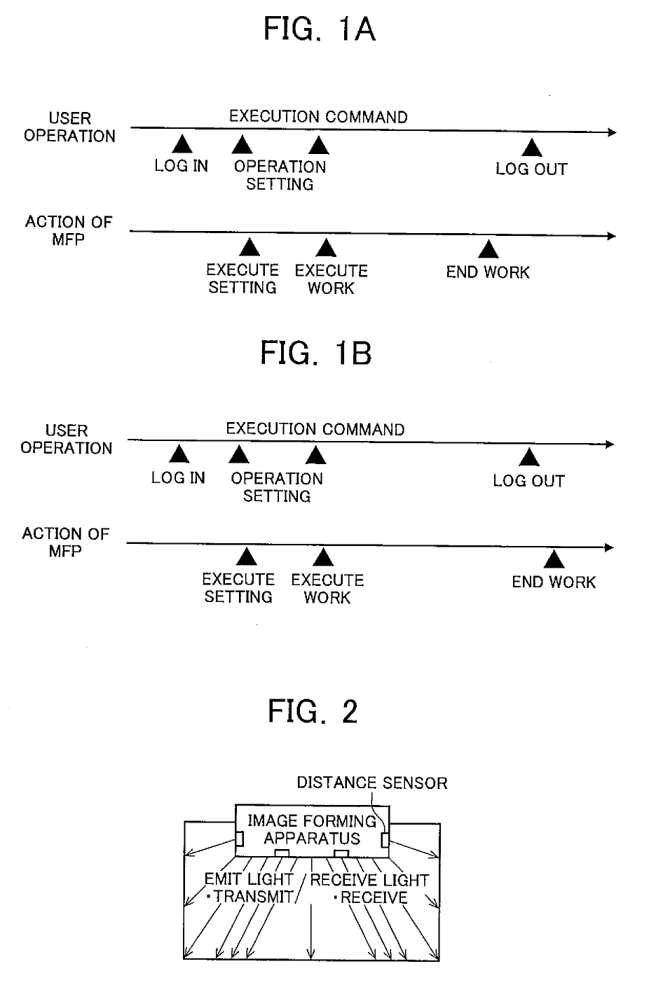

The scheme of the present invention will be described with reference to the drawings. FIGS. 1A and 1B are explanatory views of the operation state of a user and an image forming apparatus. FIG. 1A depicts a case where the user logs out after the end of a job (work) by the image forming apparatus (hereinafter “MFP”). In this case, the user stands in front of the MFP to execute a document print job, and inputs a user ID to log in to the MFP, and then makes setting on an operation environment, etc., necessary for the print job. The MFP carries out a setting processing for executing the set given job, which is then executed when the user gives an execution command. The user logs out when the given job is finished.

FIG. 1B depicts a case where the user logs out before the end of a job by the MFP. In the same manner as in the case of FIG. 1A, the user stands in front of the MFP to execute a document print job, and inputs the user ID to log in to the MFP, and then makes setting necessary for the print job. The MFP carries out the setting processing for executing of the set given job, which is then executed when the user gives an execution command. The user is allowed to log out before the end of the job, depending on the size of the job, and the job is to be finished after the user logged out.

FIG. 2 is a diagrammatic view of measurement of the distance from the MFP to the user by the MFP having a distance sensor. The MFP detects how distant the user is away from MFP and also detects whether the user is within a detection area. For detection of the user (human body, etc.), various kinds of sensors can be used, such as an infrared sensor utilizing reception/emission of infrared rays, a distance sensor utilizing an ultrasonic wave, and other distance sensors utilizing a laser beam, etc. More than one distance sensor may be provided for detecting distances in the front direction as well as the side direction. Since the user of the MFP is usually working on the MFP facing the front of it, it is possible to distinguish the user from other persons combining sensors recognizing a full face and an employee ID card, etc.

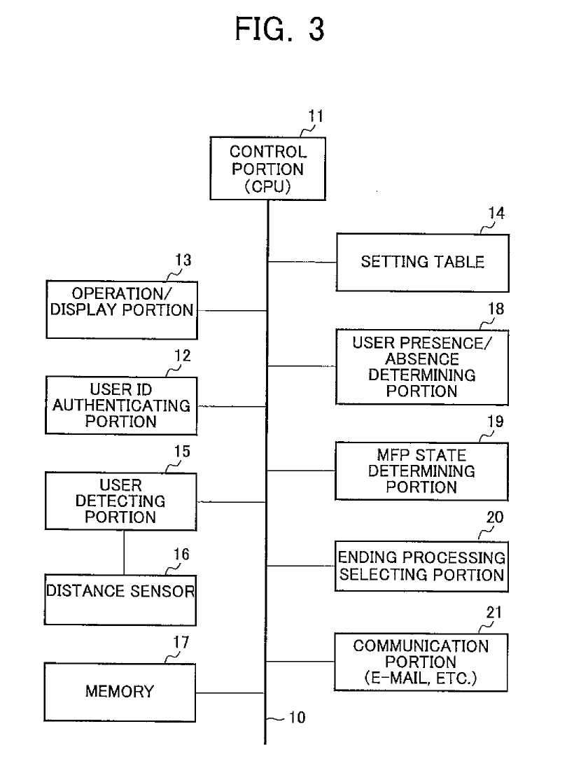

FIG. 3 is a block diagram for illustrating the scheme of the image forming apparatus of the present invention. In FIG. 3, 10 denotes a control/data line, 11 denotes a control portion, 12 denotes a user ID authenticating portion, 13 denotes an operation/display portion, 14 denotes a setting table, 15 denotes a user detecting portion, 16 denotes a distance sensor, 17 denotes a memory, 18 denotes a user presence/absence determining portion, 19 denotes an MFP state determining portion, 20 denotes an ending processing selecting portion, and 21 denotes a communicating portion.

The control portion 11 carries out overall control over the MFP, controls signal exchange between the portions, drives and controls programmed operation functions of the each portion, reads/writes data out of/in the memory, and also has a function as a CPU. In addition, the control portion 11 has a control function to shift the apparatus automatically to a predetermined ending processing after the passage of a predetermined waiting time based on the processing state of the apparatus, when the user leaves the apparatus.

The user ID authentication portion 12 identifies the user of MFP, logging in to the MFP to permit the use of the MFP. User authentication, for example, may be carried out in such a way that a noncontact, readable employee ID, etc., is fastened to the chest or hung from the neck of the user, and is read by an optical reader disposed on the front side of the MFP for authentication. In other cases, a contact type employee ID may be read by the reader for authentication or a user ID may be input at an operation portion of the MFP for authentication.

The operation/display portion 13 is the portion where the user carries out log-in operation, job input setting, etc., when the user executes a print job, etc., using the MFP. The operation/display portion 13 has a display portion that guides the user in user operation. In addition to allowing the user to set various jobs, the operation/display portion 13 also allows an individual user to call up an input menu or the setting table 14 to which the setting is done for executing an ending processing when the user leaves the MFP and to make setting for each user.

The user detecting portion 15, as illustrated in FIG. 2, measures the distance from the MFP to the user logging in to the MFP, by using the distance sensor 16. Distance data obtained by the user detecting portion 15 is sent under control of the control portion 11 to the user presence/absence determining portion 18, and is written in the memory 17 properly. The user presence/absence determining portion 18 makes a user-related determination on whether the distance between the user and the MFP becomes equal to or more than a predetermined distance, or on whether the user is out of the detection area. In response to a request from the control portion 11, the user presence/absence determining portion 18 also determines on whether a user using the MFP at present is the user having logged in to the MFP. If this determination reveals that the log-in user is actually not near the MFP, the MFP concludes that the user has moved to a place from where operating the MFP is impossible and executes the ending processing corresponding to the state of the MFP.

The state of the MFP (hereinafter “processing state of the apparatus” in the present invention) means the state of the MFP on operation, such as a state of printing a document, etc., of reading an original image (e.g., reading by a scanner), of setting a job, of jamming a paper, of running out of paper, of running out of toner, and of replacing other expendable supplies. The MFP state determining portion 19 determines “processing state of the apparatus” at the point when the user presence/absence determining portion 18 determines the absence of the user, and determines a preset waiting time and a predetermined ending processing based on the determined “processing state of the apparatus”.

The ending processing is, for example, the processing such as “waiting for execution of the next print job”, “putting the power supply in an energy-saving mode or turning off the power supply”, “suspending printing or reading”, and “logging out of the user”. At the ending processing described above, the ending processing selecting portion 20 selects the next processing to which the processing is to be shifted from the current processing state, based on the above described “user” and “processing state of the apparatus”. The communication portion 21 is provided so that the MFP inquires of the user as to the ending processing by the MFP through an e-mail, etc., when the user temporarily leaves the MFP.

The communication portion 21 automatically notifies the user who left the MFP after the passage of the predetermined time of the passage of a predetermined time by e-mail, etc., and this notification can draw the user's attention. Receiving this notification, the user can immediately return to the MFP to continue the work, or send an instruction to change the processing state of the apparatus by a reply mail. If the user is incapable of responding to the notification by sending a reply, etc., the MFP may automatically change the current processing to a preset processing after the passage of the predetermined time.

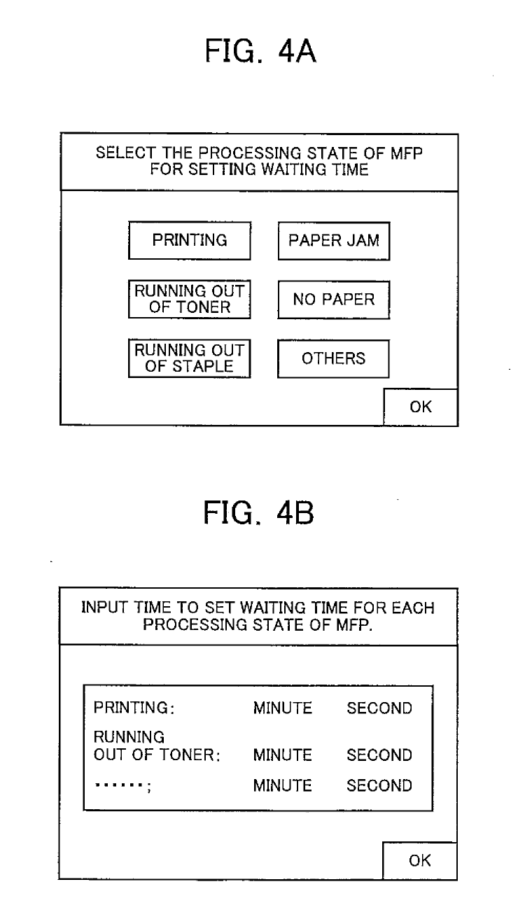

FIGS. 4A to 6 are explanatory views of settings of the above described processing state of the MFP and waiting time. These settings may be made separately for each MFP user or may be made separately every time the user logs in to the MFP, in addition to default setting.

FIG. 4A depicts an example of an input menu in which a user sets, when the user leaves the MFP for setting a processing item indicating that in what processing state of the MFP an end processing has to be executed after the passage of a predetermined waiting time. For example, as shown in FIG. 4A, items of processing states of the MFP such as “printing”, “paper jam”, “running out of toner”, “no paper”, and “running out of staples” are displayed on the menu. All items may be selected, or only the item representing a specific state may be selected.

FIG. 4B depicts an example of an input menu for setting a waiting time until an ending processing is executed in a processing state selected from the input menu shown in FIG. 4A. The waiting time is the time for preventing the MFP from executing the ending processing immediately after the user leaves the MAP. Setting this waiting time enables the MFP to be used efficiently without suspending the use of the MFP. A waiting time can be set in correspondence to the processing state of the apparatus by assuming the condition that the user can return to the MFP after leaving the MFP. For example, a longer waiting time is set when leaving the MFP during printing since it is assumed for a user to be absence longer due to a pressing matter as telephone call. No paper supply causes the user merely a little trouble of going to a given paper storage place to fetch paper, in which case a shorter time is set. In this manner, the waiting time is set in correspondence to a working environment. Besides, since an absent time varies for each user, it is desirable that a waiting time can be set separately for each user.

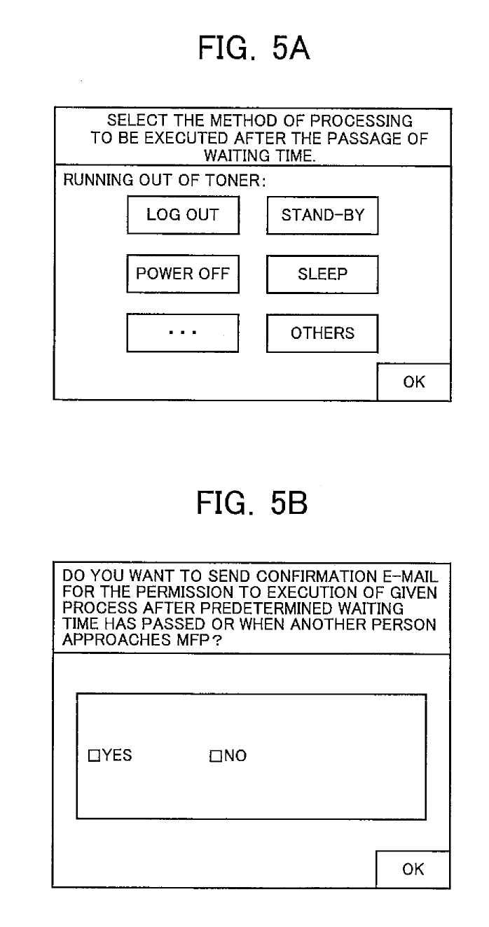

FIG. 5A depicts an example of an input menu for setting the type of an ending processing to be executed after the passage of a predetermined waiting time from the time when a user left the MFP. For example, as shown in FIG. 5A, when the MFP runs out of toner during operation and the user leaves the MFP for fetching a new bottle of toner, selection can be made to what type of a state the current state of the MFP is to be changed when not less than a predetermined waiting time has passed. The selection of processing can be made from the items, for example, “stand by mode” that allows immediate execution of a print job, “work suspension” that suspends printing or reading, “log out” that cancels the use of the apparatus, “power off” that turns off the power supply of the apparatus, or “sleep mode” that is the energy-saving mode.

FIG. 5R depicts an example of an input menu for making a selection on whether or not to notify the user of whether the current processing state of the MFP has to be changed to a preset ending processing after the passage of the above predetermined waiting time. On this menu, the user of the MFP selects “Yes” when requiring the notification, while selects “No” when not requiring the notification or having no receiving means for the notification. When “No” is selected, the current processing state of the MFP is automatically changed to the preset ending processing.

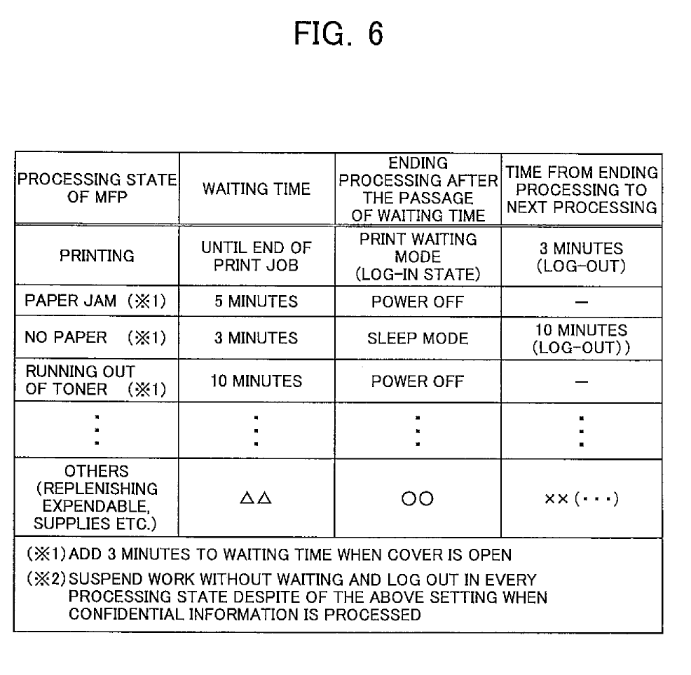

FIG. 6 depicts an example of a setting table that lists set items of the waiting times corresponding to the processing states of the MFP and of the types of ending processing. When the user leaves the MFP in the midst of operation, the processing state of the MFP changes automatically according to a processing set on the table. For example, when the user leaves the MFP while the MFP is operating in the processing state of printing, the MFP continues to operate until the end of a print job in progress. Subsequently, because of the end of printing an ending processing is executed, and this ending processing can be executed to enter the state of stand by for printing that allows the next printing. When the user does not return to the MFP after the passage of a predetermined time from the start of state of stand by for printing and when a time to wait until the next processing (e.g., three minutes) is set, for example, automatic log-out may be carried out after the passage of the set waiting time.

In a case of paper jam, for example, a waiting time for fetching an MFP administrator is supposed to be five minutes, and, if the user cannot return within this time, the power supply may be turned off as an ending processing. In a case of no paper supply, since the user merely takes a little trouble of fetching paper sheets from the paper storage place, the waiting time is set to be relatively shorter three minutes, and, if the user cannot return within this time, the power supply of the MFP may be brought into the sleep mode for energy saving.

When the MFP is in the processing state of paper jam, no paper, running out of toner, etc., a cover or tray may be kept open, which explicitly demonstrates that canceling of the current processing state is in progress. In such a case, since the user is canceling the processing state and is demonstrating his or her quick returning to the MFP, a set waiting time may automatically be extended a little longer (e.g., by three minutes). In another case, the user may leave the MFP even when the MFP is processing a document containing confidential information. In such a case, for security concern, setting of an exceptional processing should preferably be allowed, so that the processing should be immediately suspended and logged out despite of setting of the waiting time as described above.

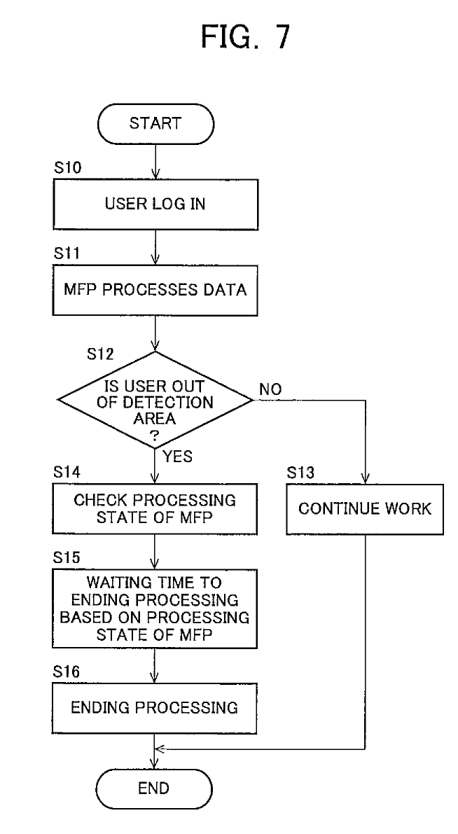

FIGS. 7 to 13 are flowcharts for explaining forms of use of the image forming apparatus of the present invention. An example of a processing flow of the basic form of use will first be described referring to FIG. 7. As described in FIGS. 1A and 1B, the user logs in to the MFP at step S10 after accepting the authentication of a user ID to the MFP. When necessary, the user is allowed to change the setting made for the case when the user leaves the MFP, which has been described referring to FIGS. 4A to 5B. Subsequently, at step S11, job setting for printing or scanner reading is carried out, and the job is executed.

While the job is being executed, the user may receive an emergency call, or such accidents of no paper supply, running out of toner, and paper jam may happen during printing. In such a case, the user of the MFP leaves the MFP to answer the call or replenish expendable supplies. At step S12, the distance sensor, etc., incorporated in the MFP detects whether the user logging in to the MFP is away from the MFP by a predetermined distance or out of the detection area. When the user is detected within a predetermined range despite of the user's slight move or shift (NO at step S12), the processing flow proceeds to step S13, and the current work (job) is continued until the end of the flow.

When it is detected that the user is out of the detection area at step S12 (YES at step S12), the processing state of the MFP at the time when the user left the MFP is checked, and a waiting time and an ending processing after the passage of the waiting time that are set for each processing state of the MFP are also checked at step S14. Then, a time that has passed from the time when the user got out of the detection area is measured at step S15. When a predetermined time (waiting time) has passed, the ending processing is executed at step S16 and the processing flow ends.

According to the above processing flow, even when the user leaves the MFP, the user can continues the work in a processing state which the MFP has been operating before the user leaves the MFP if the user returns within the predetermined waiting time. Returning within the predetermined time after leaving the MFP, therefore, eliminates a need of turning on the power supply to the MFP again or waiting for the MFP's returning to the steady mode from the energy-saving mode, and of logging in again or making setting again.

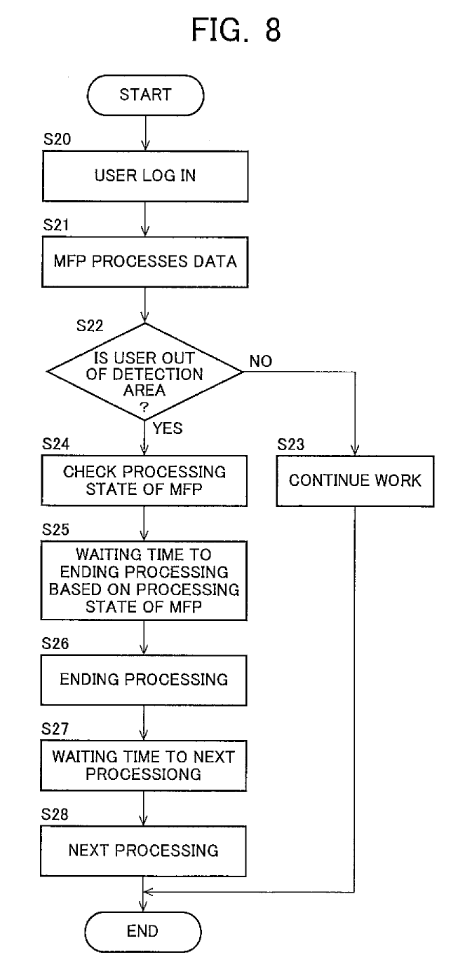

FIG. 8 is an explanatory view of an example of a processing flow for which the ending processing is carried out in two stages. The two stages of processing consist of, for example, a first processing that is an ending processing to which the processing state of the MFP is changed when the first predetermined waiting time has passed from the time when the user leaves the MFP, and a second processing that is the next processing to which the processing state is changed when an additional predetermined time has passed from the time of execution of the first processing. For example, referring to FIG. 6, when the MFP is in the processing state of no paper and a waiting time for the case when the user leaves the MFP is three minutes, an ending processing to be executed after the passage of this waiting time is the sleep mode, and this sleep mode is the first processing. When the user is unable to return to the MFP despite of the passage of ten minutes following the first processing, a log-out processing is carried out as the next processing, and this log-out processing is the second processing.

In FIG. 8, the processing flow from step S20 of user logging in to step S25 is the same as the processing flow from step S10 to step S15 in FIG. 7. The description of this part of the processing flow will therefore be omitted. When a predetermined waiting time has passed at step S25, an ending processing (the above first processing) checked for the processing state of the MFP is executed at step S26. When the user is unable to return to the MFP at this stage, the processing flow proceeds to the next step S27, at which a waiting time to the next processing (the above second processing) is measured. When this time has passed, the next processing is executed at step S28, and then the processing flow ends.

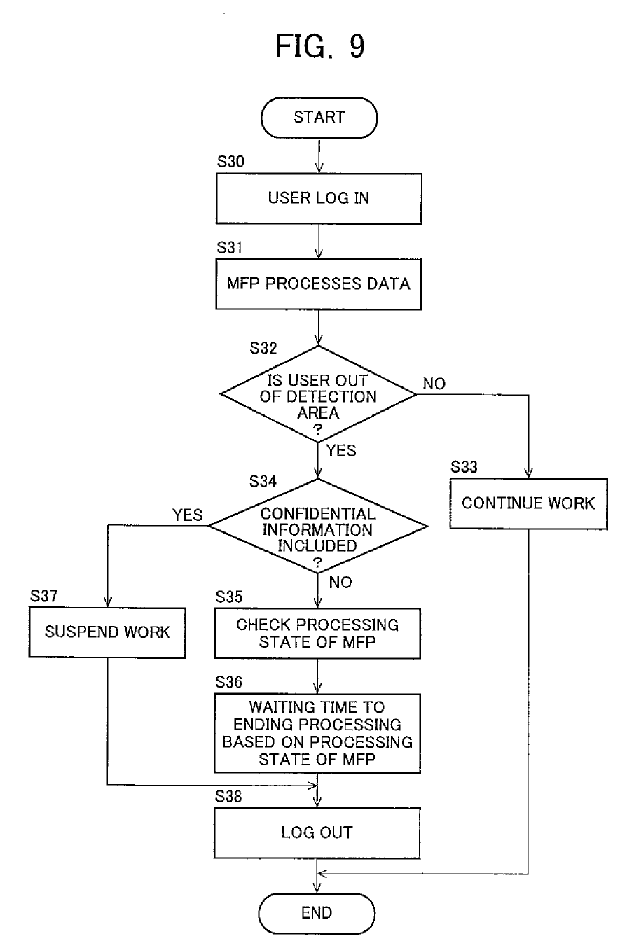

FIG. 9 is an explanatory view of an example of a processing flow in a case where a document printed or read by the MFP contains confidential information. Usually, the user does not leave the MFP without executing an ending processing when a confidential document is handled by the MFP. Nevertheless, the user may inadvertently leave the MFP without executing a predetermined ending processing depending on the processing state of the MFP. In such a case, the setting of a waiting time as described above may raise a security problem. For this reason, when a document containing confidential information is handled, the exceptional processing is carried out to immediately suspend the work and log out despite of the setting of a waiting time, as described referring to FIG. 6. Whether a document is confidential or not is automatically detected at the stage of printing or reading the document, or is specified by user input at the time of logging in.

In FIG. 9, the processing flow from step S30 of user logging in to step S33 is the same as the processing flow from step S10 to step S13 in FIG. 7. The description of this part of the processing flow will therefore be omitted. When the user of the MFP gets out of the detection area at step S32 (YES at step S32), whether a document being handled contains confidential information is determined at step S34. When the document contains confidential information (YES at step S34), the processing flow proceeds to step S37, at which printing work, etc., is suspended immediately, and then log-out processing is carried out at step 838, and the processing flow is ended.

When the document does not contain confidential information (NO at step S34), on the other hand, the processing flow proceeds to step S35, at which the processing state of the MFP at the time when the user left the MFP is checked and a waiting time and an ending processing after the passage of the waiting time that are set for each processing state of the MFP are also checked. Subsequently, a time is measured from the time when the user got out of the detection area at step S36, and when a predetermined time (waiting time) has passed, the ending processing (e.g., logging out) is executed at step S38 and the processing flow is ended.

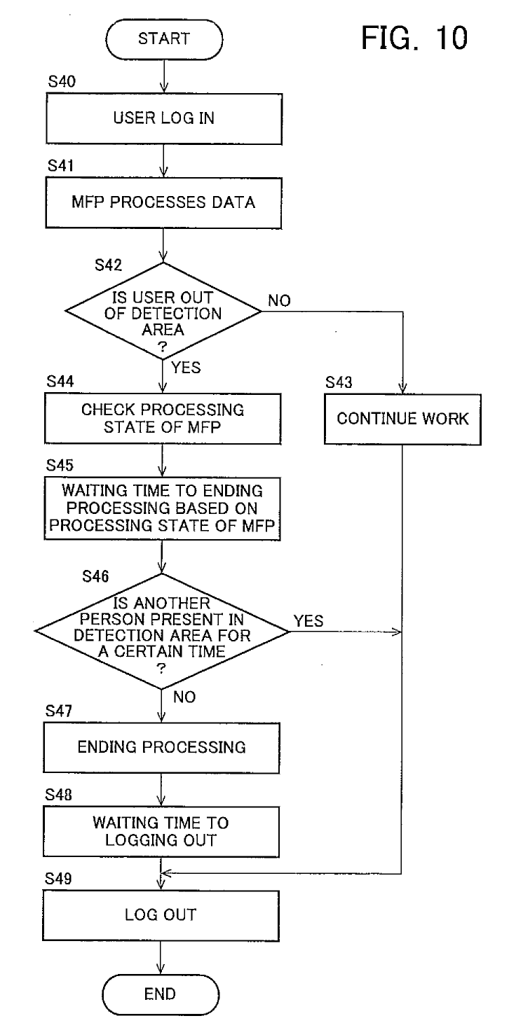

FIG. 10 is an explanatory view of an example of a processing flow in a case where another person except the user is present for a certain period of time in the human detection area during a predetermined waiting time. As the user is away from the MFP, another person except the user may enter the detection area of the MFP before the passage of the predetermined waiting time. The MFP detects another person when another person is present for a certain period of time in the detection area so as to exclude such a case where another person is present for a short time in merely passing by the MFP. When another person is present nearby the MFP for a certain period of time, another person often stays close to the MFP with an intention of using the MFP in his or her judgment that nobody is using the MFP. When the MFP is in a processing state other than the processing states of paper jam and running out of toner, the MFP is in many cases operational to another person. In such a case, it is desirable to offer such flexibility in use of the MFP by allowing another person to use the MFP to improve the overall use efficiency of the MFP.

In FIG. 10, the processing flow from step S40 of user logging in to step S44 is the same as the processing flow from step S10 to step S14 in FIG. 7. The description of this part of the processing flow will therefore be omitted. Measurement of a time is started from the time when the user got out of the detection area at step S45, and then, before the passage of this predetermined time (waiting time), the presence of another person except the user is detected in the detection area at step S46. When the presence of another person for a certain period of time is detected, the processing flow proceeds to step S49, at which the user's log out is executed and the processing flow is ended. As a result, another person is allowed to log in to the MFP to use it as a new user.

At step S46, when a time of the presence of another person in the detection area is less than a certain period of time (NO at step S46), the presence of another person is ignored as a case of just passing by the MFP, and, after the passage of the waiting time measured at step S45, the processing flow proceeds to step S47, at which a predetermined ending processing is carried out. When the next processing (e.g., log-out) is set and the user still does not return to the MFP, a waiting time to the log-out processing is measured at step S48, and the log-out processing is automatically executed after the passage of this waiting time.

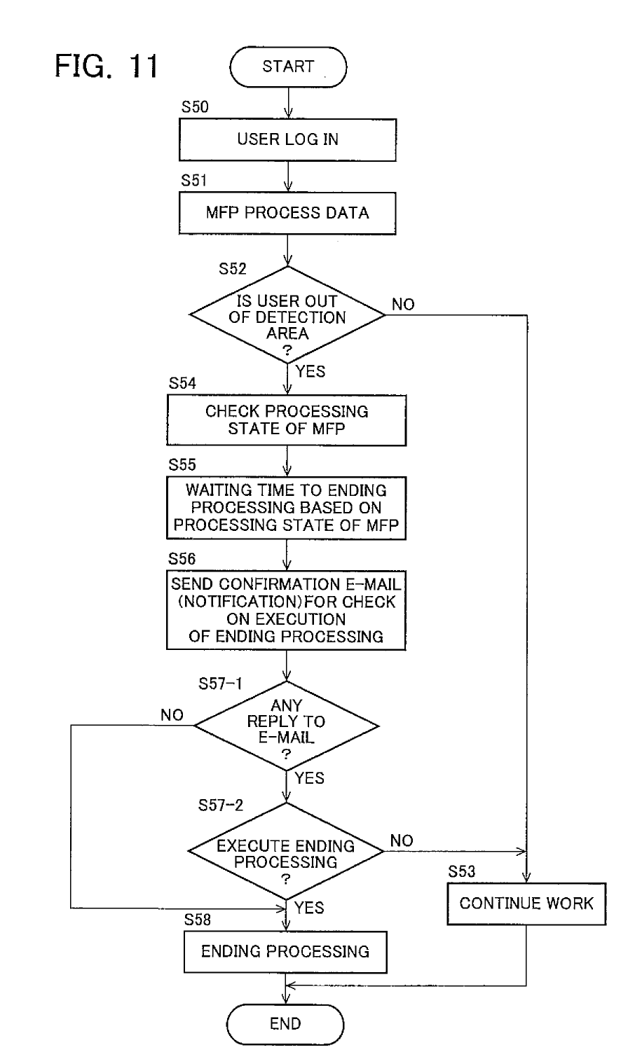

FIG. 11 is an explanatory view of an example of a processing flow for sending a notification for checking with the user one execution of an ending processing before executing a predetermined ending processing after the passage of a predetermined waiting time. In the above examples of processing flows, the MFP automatically executes the predetermined ending processing after the passage of the waiting time. However, sending a check notification to the user before the execution of the ending processing arouses the user's intension for quick returning to the MFP, thus enables more efficient use of the MFP. When the user is still unable to return to the MFP despite of reception of the notification, the processing adapted for the overall efficiency of the MFP is executed according to an automatically set processing flow. An e-mail means capable of automatic sending can be used as the check notification.

In FIG. 11, the processing flow from step S50 of user logging in to step S54 is the same as the processing flow from step S10 to step S14 in FIG. 7. The description of this part of the processing flow will therefore be omitted. Measurement of a waiting time is started from the time when the user got out of the detection area at step S55, and then, before an ending processing is executed after the passage of this predetermined time (waiting time), a notification for checking with the user on whether or not to execute the ending processing is sent to the user at step S56.

For example, a cellular phone and an e-mail by a PC can be used as a notifying means. If the user is able to return to the MFP immediately upon reception of the notification, the user is allowed to continue the work without execution of the ending processing. If the user is unable to return immediately, on the other hand, the user may send a reply in response to the notification e-mail to prevent the execution of the ending processing. When the reply to the notification is impossible, however, an ending processing adapted for the overall efficiency of the MFP is automatically executed according to a preset processing flow.

When the user sends a reply e-mail at step S57-1 (YES at step S57-1) and the execution of the ending processing is denied at step S57-2 (NO at step S57-2), the processing flow returns to step S53 and the work is continued. When the user agrees to the execution of the ending processing at step S57-2 (YES at step S57-2) and the waiting time has passed, the ending processing is executed immediately at step S58 to end the processing flow. When the user sends no reply e-mail at step S57-1 (NO at step S57-1), the processing flow proceeds to step S58, and the ending processing is executed immediately after the passage of the waiting time to end the processing flow.

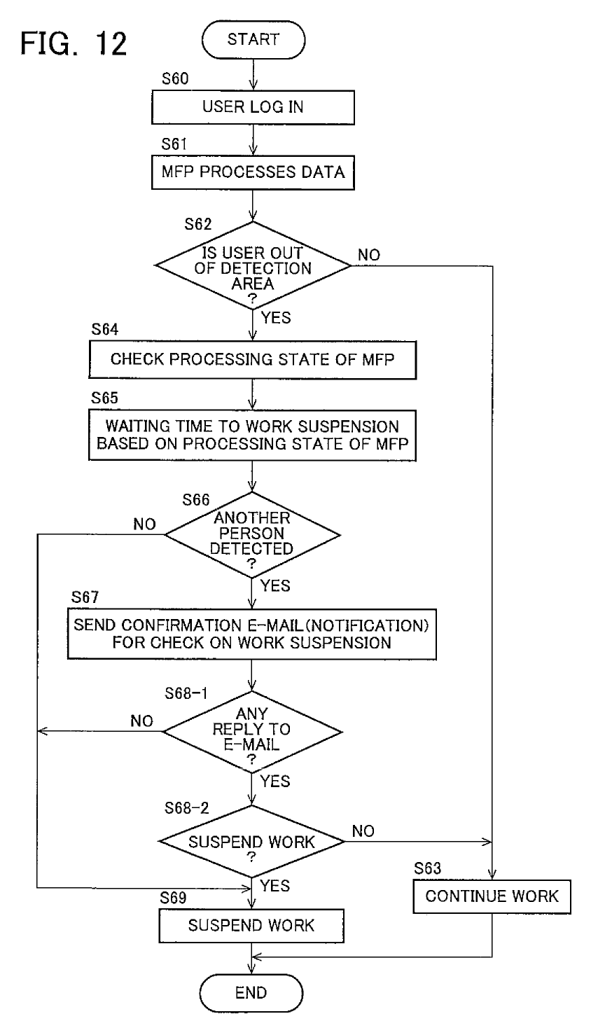

FIG. 12 is an explanatory view of an example of a processing flow for suspending the work when another person except the user of the MFP is present in the detection area during a predetermined waiting time in the case of FIG. 11 where a notification for checking with the user on execution of work suspension is sent to the user in suspending given work after the passage of a predetermined waiting time. In the case of this processing flow, detection of another person in the detection area may be confirmed under the condition of detection of a certain time of the presence that is described in FIG. 10, or may be confirmed immediately in consideration of security ensuring. In this example of processing flow, similar to the example of FIG. 11, the work can be continued if the user is able to return to the MFP immediately after reception of the notification. When immediate return is impossible, on the other hand, the user may send a reply in response to the notification e-mail to prevent the execution of work suspension. When no reply e-mail is sent, the work in progress is automatically suspended.

In FIG. 12, the processing flow from step S60 of user logging in to step S64 is the same as the processing flow from step S50 to step S54 in FIG. 11. The description of this part of the processing flow will therefore be omitted. At step S65, setting is made to suspend the work when a predetermined waiting time has passed after the user got out of the detection area of the MFP. When another person except the user is detected in the detection area of the MFP before the passage of the waiting time at step S66 (YES at step S66), a confirmation e-mail for checking with the user on whether or not to suspend the work of the MFP is sent to the user at step S67. If the user who received the confirmation e-mail immediately returns to the MFP, the count of the waiting time is reset to allow the user to continue the work of the MFP.

When the user sends a reply e-mail at step S68-1 (YES at step S68-1) and work suspension is denied at step S68-2 (NO at step S68-2), the processing flow returns to step S63, and the work is continued. When the user agrees to work suspension at step S68-2 (YES at step S68-2), work suspension is executed immediately at step S69 and the processing flow is ended. When the user sends no reply e-mail at step S68-1 (NO at step S68-1), the processing flow proceeds to step S69, and work suspension is executed immediately and the processing flow is ended.

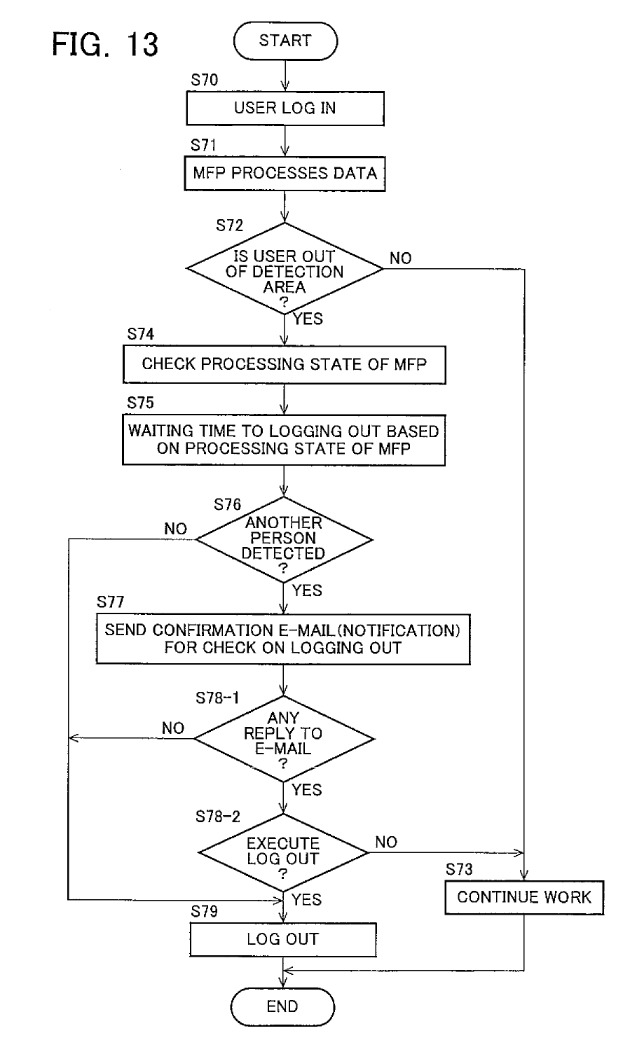

FIG. 13, a modification of the processing flow of FIG. 12, is an explanatory view of an example of a processing flow for logging out to allow another person to use the MFP when another person except the user is present in the detection area during a predetermined waiting time. In the case of this processing flow, detection of another person in the detection area of the MFP may be confirmed under the condition of detection of a certain time of the presence that is described in FIG. 10, or may be confirmed immediately in consideration of security ensuring. In this example of processing flow, the user may send a reply in response to a notification e-mail to prevent the execution of a log-out processing. When no reply e-mail is sent, the log-out processing is executed automatically.

In FIG. 13, the processing flow from step S70 of user logging in to step S74 is the same as the processing flow from step S60 to step S64 in FIG. 12. The description of this part of the processing flow will therefore be omitted. At step S75, setting is made to carry out the log-out processing when a predetermined waiting time has passed after the user got out of the detection area of the MFP. When another person except the user is detected in the detection area of the MFP before the passage of the waiting time at step S76 (YES at step S76) a confirmation e-mail for checking with the user on whether or not to log out is sent to the user at step S77. If the user who received the confirmation e-mail immediately returns to the MFP, the count of the waiting time is reset to maintain the user's logging in to the MFP, and the user continues the work.

When the user sends a reply e-mail at step S78-1 (YES at step S78-1) and logging out is denied at step S78-2 (NO at step S78-2), the processing flow returns to step S73, and the user's logging in is maintained to continue the work. When the user agrees to logging out at step S78-2 (YES at step S78-2), logging out is executed immediately at step S79 and the processing flow is ended. When the user does not send reply e-mail at step S78-1 (NO at step S78-1), the processing flow proceeds to step S79, and logging out is executed immediately and the processing flow is ended.

According to the present invention, when a user leaves an image forming apparatus for a little while for the reason of, for example, running out of toner, no paper, paper jam, etc., a waiting time and an ending processing corresponding to the processing state of the apparatus can be set so that such an ending processing as work suspension and logging out is not carried out automatically. As a result, the use efficiency of the apparatus is improved through continuation of print work, etc. When the user is unable to return to the apparatus in a short time, automatic logging out is carried out to improve flexibility and convenience for another person in use of the apparatus, or the mode of the apparatus is changed to an energy-saving mode to save consumption power.

1. An image forming apparatus comprising:
a human body detecting portion detecting a distance from the apparatus to a user; and
a control portion causing the apparatus to automatically shift the apparatus to a given state when the distance to the user becomes equal to or more than a predetermined distance or the user is out of a detection area, wherein
the image forming apparatus executes an ending processing after passage of a predetermined time, based on a processing state of the apparatus.

2. The image forming apparatus as defined in claim 1, wherein
the predetermined time can be set separately for each user of the apparatus.

3. The image forming apparatus as defined in claim 1, wherein
a processing state of the apparatus is any one of states of printing, reading, paper jam, running out of toner, and no papers.

4. The image forming apparatus as defined in claim 1, wherein
the ending processing is an energy-saving processing of a power supply of the apparatus.

5. The image forming apparatus as defined in claim 1, wherein
the ending processing is a work suspension processing of printing or reading.

6. The image forming apparatus as defined in claim 1, wherein
the ending processing is a log-out processing of the user.

7. The image forming apparatus as defined in claim 1, wherein
a work suspension processing and a log-out processing are executed regardless of the processing state of the apparatus in a case of image processing involving confidential information.

8. The image forming apparatus as defined in claim 1, wherein
a log-out processing is executed regardless of the processing state of the apparatus when a person other than the user is detected for a certain period of time or longer in the detection area before passage of the predetermined time.

9. The image forming apparatus as defined in claim 1, wherein
a communication portion notifies the user of the execution of the ending processing after passage of the predetermined time.

10. The image forming apparatus as defined in claim 1, wherein
a communication portion notifies the user of execution of a work suspension processing when a person other than the user is detected for a certain period of time or longer in the detection area before passage of the predetermined time.

11. The image forming apparatus as defined in claim 1, wherein
a communication portion notifies the user of execution of log-out processing when a person other than the user is detected for a certain period of time or longer in the detection area before passage of the predetermined time.
